(19) United States
(12) Patent Application Publication
(10) Pub. No.: US 2026/0260152 A1
(43) Pub. Date: Sep. 3, 2026

(54) RECORDING MEDIUM, INFORMATION PROCESSING METHOD, AND INFORMATION PROCESSING DEVICE

(71) Applicant: Fujitsu Limited, Kawasaki-shi (JP)

(72) Inventor: Naoki IIJIMA, Kawasaki (JP)

(73) Assignee: Fujitsu Limited, Kawasaki-shi (JP)

(21) Appl. No.: 19/546,861

(22) Filed: Feb. 23, 2026

(30) Foreign Application Priority Data
Feb. 28, 2025 (JP) 2025-031322

(51) Int. Cl. G06N 10/60; G06N 10/40

(52) U.S. Cl. CPC G06N 10/60; G06N 10/40

(57) ABSTRACT

A computer-readable recording medium stores therein a program for causing a computer to execute a process, the process including: calculating energy of a molecule based on energy of each of multiple fragments obtained by dividing a structure of the molecule by a molecule dividing method, the calculating including: estimating, for each of the multiple fragments, a candidate value from which noise has been removed, based on multiple candidate values that are calculated by a variational quantum eigenvalue solver, each of the multiple candidate values being calculated for each of a multiple parameters of a first variational quantum circuit representing a Hamiltonian of the each of the multiple fragments, the each of the multiple candidate values being a potential solution of the parameter; and calculating, for each of the multiple fragments, an energy thereof based on the candidate value from which noise has been removed and estimated for each of the multiple parameters.

### CROSS REFERENCE TO RELATED APPLICATIONS

This application is based upon and claims the benefit of priority of the prior Japanese Patent Application No. 2025-031322, filed on Feb. 28, 2025, the entire contents of which are incorporated herein by reference.

### FIELD

The embodiments discussed herein are related to a recording medium, an information processing method, and an information processing device.

### BACKGROUND

Conventionally, in the field of drug discovery, material development, or the like, there is a quantum chemical calculation technique for analyzing the structure or properties of a molecule that is a candidate for a drug or a material. In the quantum chemical calculation, for example, the energy of a molecule is calculated. The energy is the ground or excitation energy. Here, in order to reduce the processing amount of the quantum chemical calculation, there is a molecule dividing method in which the structure of a molecule is split into multiple fragments, and the energy of each fragment is calculated and integrated to calculate the energy of the molecule. Examples of the molecular division method include Bootstrap Embedding (BE) and Density Matrix Embedding Theory (DMET).

As the related art, for example, there is a technique of calculating molecular energy corresponding to an interatomic distance. Further, for example, there is a technique of executing a variational quantum amplitude estimation algorithm. Also, for example, there is a technique of performing a single-particle basis rotation in a qubit system that encodes the state of a chemical system, measuring the Jordan-Wigner transform of the particle density operator, and determining the energy of the chemical system. For example, there is a technique of stochastically canceling noise in a measurement-based quantum device. For example, refer to Japanese Laid-Open Patent Publication No. 2024-047969, Japanese Laid-Open Patent Publication No. 2023-039444, U.S. Patent Application Publication No.2022/0254453, and U.S. Patent Application Publication No. 2023/0196172.

### SUMMARY

According to an aspect of an embodiment, a computer-readable recording medium stores therein a program for causing a computer to execute a process, the process comprising:
calculating energy of a molecule based on energy of each of a plurality of fragments obtained by dividing a structure of the molecule by a molecule dividing method, the calculating including: estimating, for each of the plurality of fragments, a candidate value from which noise has been removed, based on a plurality of candidate values that are calculated by a variational quantum eigenvalue solver, each of the plurality of candidate values being calculated for each of a plurality of parameters of a first variational quantum circuit representing a Hamiltonian of the each of the plurality of fragments, the each of the plurality of candidate values being a potential solution of the parameter; and calculating, for each of the plurality of fragments, an energy thereof based on the candidate value from which noise has been removed and estimated for each of the plurality of parameters.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is an explanatory diagram depicting an example of an information processing method according to an embodiment.

FIG. 2 is an explanatory diagram depicting an example of an information processing system 200.

FIG. 3 is a block diagram of an example of a hardware configuration of an information processing device 100.

FIG. 4 is a block diagram depicting an example of a hardware configuration of a chemical calculating device 201.

FIG. 5 is a block diagram depicting an example of a functional configuration of the information processing device 100.

FIG. 6 is an explanatory diagram depicting an operation policy.

FIG. 7 is an explanatory diagram depicting an operation example of the information processing device 100.

FIG. 8 is an explanatory diagram depicting an operation example of the information processing device 100.

FIG. 9 is an explanatory diagram depicting an example of an effect.

FIG. 10 is a flowchart depicting an example of a procedure of an overall process.

FIG. 11 is a flowchart depicting an example of a procedure of a calculation process.

### DESCRIPTION OF EMBODIMENTS

First, problems associated with the conventional techniques are discussed. In the related art, it is difficult to improve the accuracy of the calculation of the energy of the molecule when the molecule dividing method is used. For example, when the energy of a fragment is calculated by a variational quantum eigenvalue solver using an actual quantum computer, the accuracy of the calculation of the energy of a molecule may be reduced due to the effects of noise.

Embodiments of a recording medium, an information processing method, and an information processing device according to the present disclosure will be explained below in detail with reference to the accompanying drawings.

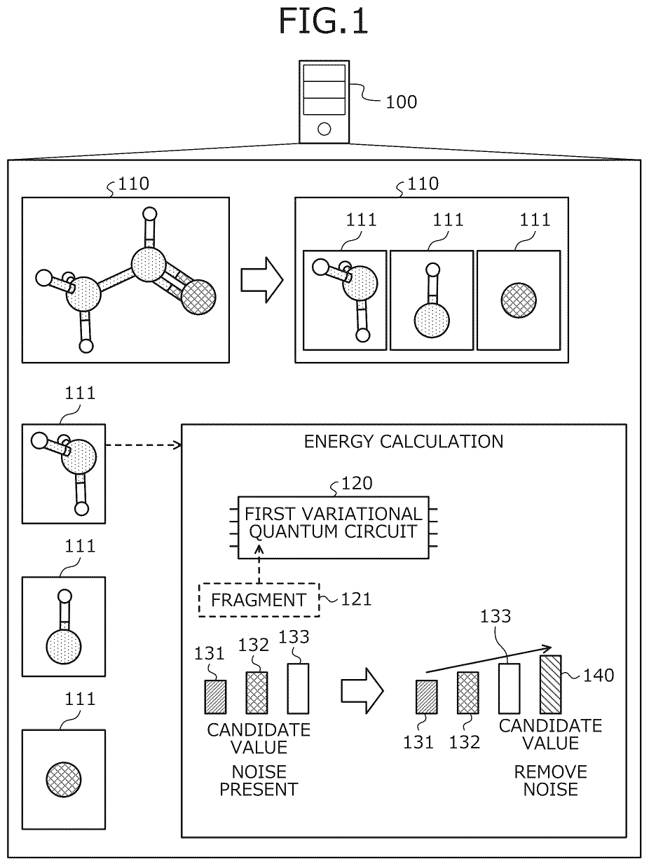

FIG. 1 is an explanatory diagram depicting an example of an information processing method according to an embodiment. The information processing device 100 is a computer for calculating the energy of a molecule using a molecule dividing method. The information processing device 100 is, for example, a server or a personal computer (PC).

Conventionally, it is desired to perform quantum chemical calculation in the field of drug discovery, material development, or the like. The quantum chemical calculation is, for example, calculation of the energy of a molecule. The energy is the ground or excitation energy.

Here, there is a method called a variational quantum eigenvalue solver for calculating the energy of a molecule. In the following description, the variational quantum eigen solver may be referred to as a “variational quantum eigen solver (VQE)”.

A VQE is a variational algorithm. For example, the VQE sets a variational quantum circuit representing a Hamiltonian of a molecule, and updates parameters of the set variational quantum circuit so as to minimize an expected value of the Hamiltonian. The variational quantum circuit manipulates, for example, a quantum state representing a molecular state.

The VQE is executed using, for example, an actual quantum computer of a scale called a noisy intermediate-scale quantum computer (NISQ). In NISQ, an error may occur in a quantum state due to noise. The noise is, for example, environmental noise, interference noise between quantum bits, noise during operation of quantum bits, or the like.

However, as the size of the molecule increases, the influence of the noise in the NISQ on the accuracy of the calculation of the energy of the molecule by the VQE tends to increase. The scale is the number of atoms forming the molecule, etc. Therefore, it is difficult to maintain the accuracy of calculations of the energy of the molecule. In addition, as the size of the molecule increases, the processing time and processing load necessary to calculate the energy of the molecule may increase.

On the other hand, in order to reduce the processing time and the processing load necessary for calculating the energy of the molecule while maintaining the accuracy of the calculation of the energy of the molecule, there is a molecule dividing method of splitting the structure of the molecule into multiple fragments. In the molecular division method, the energy of the molecule is calculated by calculating and integrating the energy of each fragment.

In the process of calculating the energy of each fragment in the molecular division method, for example, VQE may be utilized. Specifically, it is conceivable to calculate the energy of a fragment based on a result of calculating an eigenvalue problem using a Hamiltonian by VQE. Examples of the molecular division method include Bootstrap Embedding (BE) and Density Matrix Embedding Theory (DMET).

However, when the molecular division method is used, it is difficult to improve the accuracy of the calculation of the energy of the molecule. For example, a case is conceivable in which the energy of each fragment is calculated by utilizing VQE using an actual quantum computer. In this case, the calculation of the energy of each fragment is affected by noise in the actual quantum computer, which may lead to a decrease in the accuracy of the calculation of the energy of the molecule.

In this regard, there is a technique called Zero Noise Extrapolation (ZNE) for suppressing the influence of noise on an actual quantum computer. ZNE is applied, for example, when the energy of a molecule is calculated by VQE. Specifically, ZNE calculates, by the VQE, the energy of a molecule affected by noise by using each variational quantum circuit of multiple variational quantum circuits having different degrees of influence of noise, and estimates the energy of a molecule not affected by noise.

Similarly, it is desirable to improve the accuracy of the calculation of the energy of a molecule by applying ZNE to the molecule dividing method. Conventionally, a method of applying ZNE to a molecular division method has not been proposed. For example, in the molecule dividing method, an eigenvalue problem using a Hamiltonian is calculated by VQE without directly calculating energy. Therefore, there is a problem that ZNE cannot be simply applied to VQE in the molecular division method. As a result, it is difficult to improve the accuracy of the calculation of the energy of the molecule using the molecule dividing method.

Therefore, in the present embodiment, an information processing method capable of improving the accuracy of the calculation of the energy of a molecule using a molecule dividing method will be described.

In FIG. 1, the information processing device 100 identifies each of multiple fragments 111 obtained by dividing a molecular structure 110. The information processing device 100 sets a Hamiltonian of each fragment 111. The information processing device 100 calculates the energy of the molecule by calculating and integrating the energy of each fragment 111 by the molecule dividing method. At this time, specifically, the information processing device 100 calculates the energy of each fragment 111 as described in (1-1) and (1-2) below.

(1-1) For each of the fragments 111, the information processing device 100 obtains multiple candidate values that may be solutions of the parameters 121 included in the first variational quantum circuit 120. The first variational quantum circuit 120 represents a Hamiltonian of the fragment 111. The first variational quantum circuit 120 is, for example, a minimum-scale variational quantum circuit that expresses the Hamiltonian of the fragment 111. For example, when the first variational quantum circuit 120 is executed by an actual quantum computer, noise may be generated. The first variational quantum circuit 120 manipulates a quantum state representing a molecular state.

The multiple candidate values are calculated by the VQE through the actual quantum computer. Each of the multiple candidate values is a candidate value affected by noise in the actual machine of the quantum computer when a specific variational quantum circuit is executed. Specifically, the multiple candidate values are candidate values having different degrees of influence of noise. In the example depicted in FIG. 1, the multiple candidate values are specifically candidate values 131 to 133.

The candidate value 131 is, for example, a candidate value that is calculated by the VQE using the first variational quantum circuit 120 and is treated as being affected by a reference noise caused by the first variational quantum circuit 120. In other words, the candidate value 131 is, for example, a candidate value that is treated as being affected by one time the reference noise caused by the first variational quantum circuit 120.

The candidate value 132 is, for example, a candidate value that is calculated by the VQE using the superposition of the first variational quantum circuit 120 and is treated as being affected by three times the reference noise caused by the first variational quantum circuit 120 as compared with the candidate value 131. Here, the superposition corresponds to, for example, sequentially coupling the first variational quantum circuit 120, a front-back inversion of the first variational quantum circuit 120, and the first variational quantum circuit 120.

The candidate value 133 is, for example, a candidate value that is calculated by the VQE using the superposition of the first variational quantum circuit 120 and is treated as being influenced by five times the reference noise caused by the first variational quantum circuit 120 as compared with the candidate value 131. Here, the superposition corresponds to, for example, sequentially coupling the first variational quantum circuit 120, the front-back inversion of the first variational quantum circuit 120, the first variational quantum circuit 120, the front-back inversion of the first variational quantum circuit 120, and the first variational quantum circuit 120.

(1-2) For each fragment 111, the information processing device 100 estimates a candidate value from which noise has been removed based on the obtained multiple candidate values for each parameter 121 included in the first variational quantum circuit 120. In the example depicted in FIG. 1, specifically, the information processing device 100 estimates the candidate value 140 from which noise has been removed, based on the three candidate values 131 to 133 that are treated as being affected by one time, three times, and five times the reference noise, respectively. In other words, the candidate value 140 is, for example, a candidate value that is treated as being affected by zero times the reference noise. In other words, the candidate value 140 is, for example, a candidate value that is treated as not being affected by reference noise.

As a result, the information processing device 100 may obtain, for each of the fragments 111, a solution of each of the parameters 121 included in the first variational quantum circuit 120 without being affected by noise in the actual quantum computer.

(1-3) For each fragment 111, the information processing device 100 calculates the energy of the fragment 111 based on the candidate value from which noise is removed (noise-removed candidate value) estimated for each parameter 121 included in the first variational quantum circuit 120.

For example, the information processing device 100 calculates a reduced density matrix for each fragment, 111 based on the noise-removed candidate value estimated for each parameter 121 included in the first variational quantum circuit 120. For example, for each fragment 111, the information processing device 100 calculates the energy of the fragment 111 based on the calculated reduced density matrix. In the following description, the reduced density matrix may be referred to as “reduced density matrix (RDM)”.

Accordingly, the information processing device 100 may improve the accuracy of the calculation of the energy of each fragment 111. The information processing device 100 may suppress the influence of noise in an actual quantum computer and improve the accuracy of the calculation of the energy of each fragment 111. As a result, the information processing device 100 may improve the accuracy of the calculation of the energy of the molecule based on the energy of each fragment 111. The information processing device 100 may reduce the processing time and the processing load necessary to calculate the energy of the molecule while maintaining the accuracy of the calculation of the energy of the molecule by the molecule dividing method.

Here, while a case in which functions of the information processing device 100 are realized by a single computer has been described, the present disclosure is not limited hereto. For example, functions of the information processing device 100 may be realized by cooperation of multiple computers. For example, functions of the information processing device 100 may be implemented on a cloud.

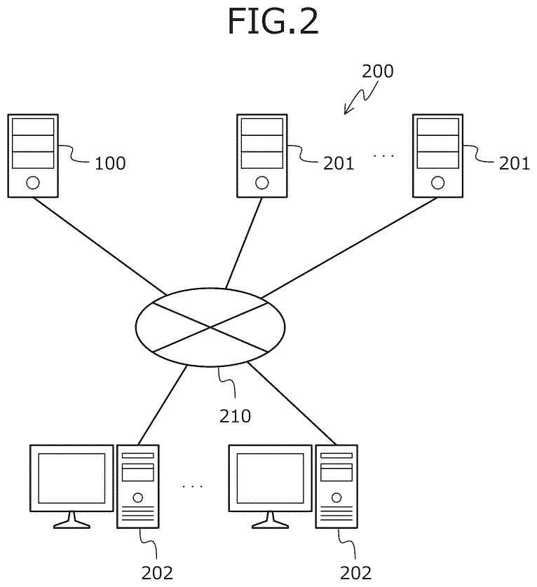

Next, an example of an information processing system 200 to which the information processing device 100 depicted in FIG. 1 is applied will be described with reference to FIG. 2.

FIG. 2 is an explanatory diagram depicting an example of the information processing system 200. In FIG. 2, the information processing system 200 includes the information processing device 100, one or more chemical calculating devices 201, and one or more client devices 202.

In the information processing system 200, the information processing device 100 and the chemical calculating devices 201 are connected via a wired or wireless network 210. The network 210 is, for example, a local area network (LAN), a wide area network (WAN), the Internet, or the like. In the information processing system 200, the information processing device 100 and the client devices 202 are connected via the wired or wireless network 210.

The information processing device 100 is a computer for controlling quantum chemical calculations. Quantum chemical calculations include, for example, calculating the energy of a molecule of interest. The energy is, for example, ground energy or excitation energy. The information processing device 100 obtains a processing request that requests execution of quantum chemical calculation for a molecule of interest by using the molecule partitioning method. Examples of the molecular division method include BE and DMET.

The processing request includes, for example, structural information indicating the structure of the molecule of interest. The structural information includes, for example, coordinates of each atom among multiple atoms forming the molecule of interest. The structural information includes, for example, the type of each of the atoms forming the molecule of interest. The processing request may include, for example, a division number indicating how many fragments the structure of the molecule of interest is to be divided into. The number of divisions may be set in advance by the user, for example.

The information processing device 100 identifies the structure of the molecule of interest based on the structure information included in the processing request. The information processing device 100 generates fragment information indicating each fragment by dividing the structure of the identified molecule of interest into multiple fragments corresponding to the number of divisions. Based on the fragment information, the information processing device 100 expands DMET as described below and performs quantum chemical calculation for calculating the energy of the molecule of interest.

For example, the information processing device 100 iteratively performs a series of processes of calculating the energy of each fragment until a predetermined exit condition is satisfied in cooperation with the chemical calculating device 201. The predetermined exit condition is, for example, that the sum of the number of atoms of each fragment matches the number of atoms of the molecule.

The series of processes includes, for example, a first process of calculating a solution of each parameter of a variational quantum circuit representing a Hamiltonian by calculating an eigenvalue problem using the Hamiltonian using the VQE for each fragment. The series of processes includes, for example, a second process of calculating a quantum density matrix for each fragment based on the calculated solution of each parameter and calculating energy of the fragment based on the calculated quantum density matrix. The series of processes includes, for example, a third process of updating the Hamiltonian of each fragment when a predetermined exit condition is not satisfied when the energy of each fragment is calculated.

Specifically, when performing the first process, the information processing device 100 prepares, for each fragment, multiple variational quantum circuits having different degrees of influence of noise, based on a reference variational quantum circuit representing a Hamiltonian of the fragment. The multiple variational quantum circuits include, for example, a variational quantum circuit that is logically equivalent to a reference variational quantum circuit and has a scale different from that of the reference variational quantum circuit. The multiple variational quantum circuits may include, for example, a variational quantum circuit serving as a reference.

Specifically, the information processing device 100 causes the chemical calculating device 201 to execute each variational quantum circuit for each fragment, thereby calculating multiple candidate values that may be solutions of each parameter of the variational quantum circuit serving as a reference by the VQE. The multiple candidate values have different degrees of influence of noise. Specifically, for each fragment, the information processing device 100 calculates, for each parameter of the variational quantum circuit serving as a reference, a candidate value to be treated as not being affected by noise, which is a solution of the parameter, the candidate value being calculated based on the multiple calculated candidate values.

When a predetermined exit condition is satisfied, the information processing device 100 calculates the energy of the molecule of interest, based on the energy of each fragment calculated last. The information processing device 100 outputs the calculated energy of the molecule of interest as a result of performing the quantum chemical calculation on the molecule of interest. The output format is, for example, display on a display, print output to a printer, transmission to another computer, or storage in a storage area. The other computer is, for example, one of the client devices 202.

For example, the information processing device 100 transmits the calculated energy of the molecule of interest to the client device 202 as a result of performing the quantum chemical calculation on the molecule of interest. For example, the information processing device 100 may output the calculated energy of the molecule of interest as a result of performing the quantum chemical calculation on the molecule of interest so that the user may refer to the energy. The information processing device 100 is, for example, a server or a PC.

The chemical calculating device 201 is a computer that performs quantum chemical calculation on molecules. The chemical calculating device 201 executes the variational quantum circuit under the control of the information processing device 100. The chemical calculating device 201 returns a result of executing the variational quantum circuit to the information processing device 100. The chemical calculating device 201 is, for example, an actual machine of a quantum computer. The chemical calculating device 201 may be, for example, a server or a PC having a quantum simulator with noise.

The client device 202 is a computer utilized by a user who desires to perform a quantum chemical calculation on a molecule of interest. The user is, for example, an operator. The client device 202 generates a processing request that requests execution of the quantum chemical calculation for the molecule of interest using the molecule dividing method in response to the operation input of the user. The client device 202 obtains structure information indicating the structure of the molecule of interest, for example, in response to an operation input by the user. The client device 202 generates, for example, a processing request including structural information indicating the structure of the molecule of interest.

The client device 202 transmits the generated processing request to the information processing device 100. The client device 202 receives, from the information processing device 100, a result of performing the quantum chemical calculation on the molecule of interest. For example, the client device 202 receives the energy of the molecule of interest from the information processing device 100 as a result of performing quantum chemical calculation on the molecule of interest. The client device 202 outputs the result of performing the quantum chemical calculation on the molecule of interest so that the user may refer to the result. The client device 202 is, for example, a PC, a tablet terminal, or a smartphone.

Here, while a case in which the information processing device 100 is a device different from the chemical calculating device 201 has been described, the present disclosure is not limited hereto. For example, the information processing device 100 may have a function of the chemical calculating device 201 and may also operate as the chemical calculating device 201. In this case, the information processing system 200 may omit the chemical calculating device 201.

Here, while a case in which the information processing device 100 is a device different from the client device 202 has been described, the present disclosure is not limited hereto. For example, the information processing device 100 may have a function of the client device 202 and may also operate as the client device 202. In this case, the information processing system 200 may omit the client device 202.

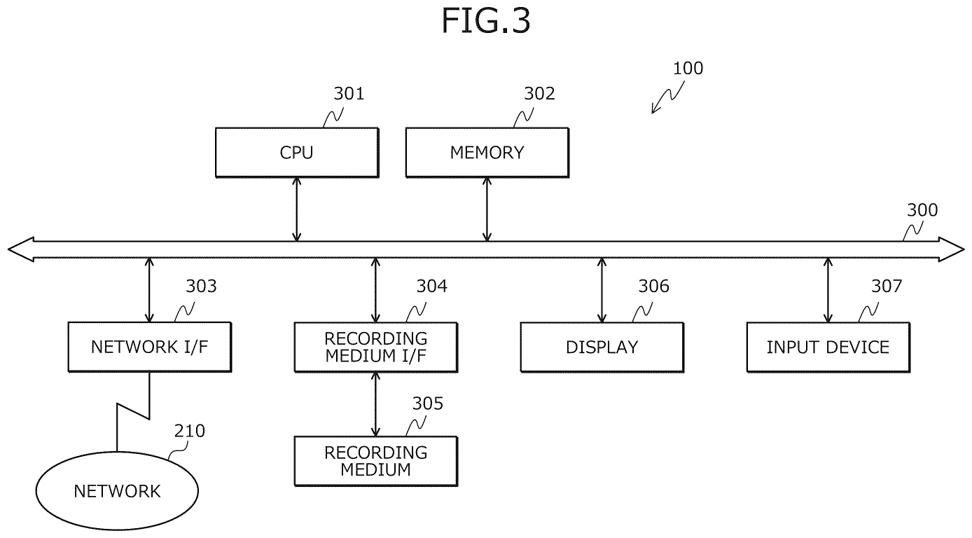

Next, with reference to FIG. 3, an example of a hardware configuration of the information processing device 100 is described.

FIG. 3 is a block diagram of an example of the hardware configuration of the information processing device 100. In FIG. 3, the information processing device 100 has a central processing unit (CPU) 301, a memory 302, and a network interface (I/F) 303. The information processing device 100 also has a recording medium I/F 304, a recording medium 305, a display 306, and an input device 307. Further, the components are connected to each other by a bus 300.

Here, the CPU 301 governs overall control of the information processing device 100. The memory 302, for example, includes a read-only memory (ROM), a random-access memory (RAM), and a flash-ROM. In particular, for example, the flash-ROM and/or ROM stores therein various programs and the RAM is used as a work area of the CPU 301. Programs stored to the memory 302 are loaded onto the CPU 301, whereby encoded processes are executed by the CPU 301.

The network I/F 303 is connected to the network 210 via a communications line and is connected to other computers through the network 210. Further, the network I/F 303 administers an internal interface with the network 210 and controls the input and output of data with respect to the other computers. The network I/F 303, for example, is a modem, a LAN adapter, or the like.

The recording medium I/F 304 controls the reading and writing of data with respect to the recording medium 305 under the control of the CPU 301. The recording medium I/F 304 is, for example, a disk drive, a solid-state drive (SSD), a universal serial bus (USB) port, or the like. The recording medium 305 is a nonvolatile memory storing data written thereto under the control of the recording medium I/F 304. The recording medium 305 is, for example, a disk, a semiconductor memory, a USB memory, or the like. The recording medium 305 may be removable from the information processing device 100.

The display 306 displays data such as a cursor, icons, toolboxes, documents, images, or functional information. The display 306 is, for example, a cathode ray tube (CRT), a liquid crystal display, or an organic electroluminescence (EL) display. The input device 307 includes keys for inputting characters, numbers, or various instructions, and inputs data. The input device 307 is, for example, a keyboard or a mouse. The input device 307 may be, for example, a touch panel-type input pad, a numeric keypad, or the like.

The information processing device 100 may include, for example, a camera in addition to the above-described components. Further, the information processing device 100 may include, for example, a printer, a scanner, a microphone, a speaker, or the like in addition to the above-described components. The information processing device 100 may include, for example, the recording medium I/F 304 and/or the recording medium 305 in plural. The information processing device 100 may omit, for example, the display 306 and/or the input device 307. The information processing device 100 may omit the recording medium I/F 304 and the recording medium 305, for example.

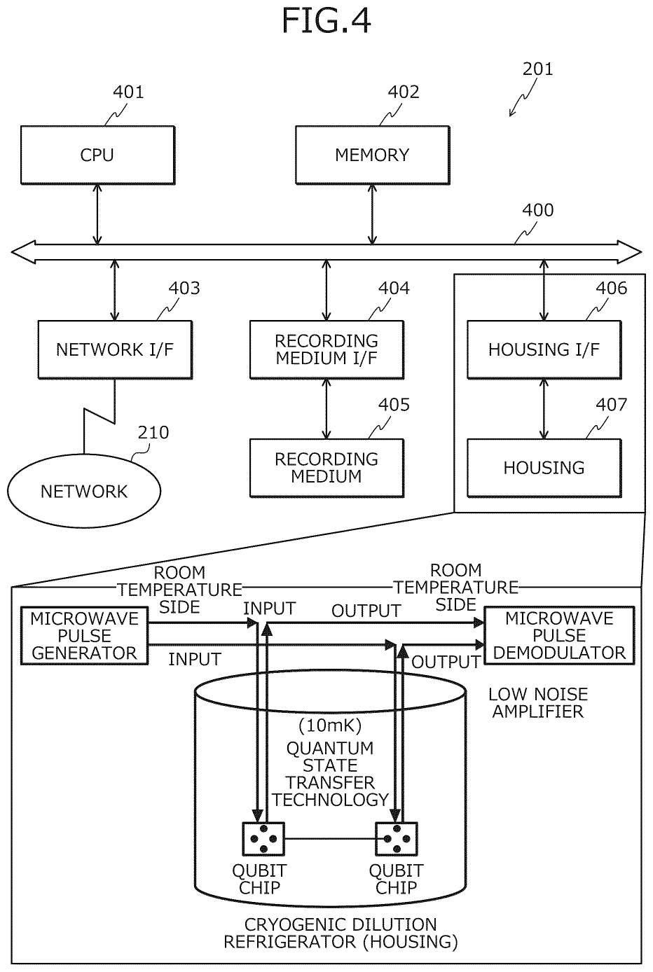

With reference to FIG. 4, an example a hardware configuration of the chemical calculating device 201 is described.

FIG. 4 is a block diagram depicting an example of a hardware configuration of the chemical calculating device 201. In FIG. 4, the chemical calculating device 201 has a CPU 401, a memory 402, a network I/F 403, a recording medium I/F 404, and a recording medium 405. The chemical calculating device 201 further has a housing I/F 406 and a housing 407. Further, the components are coupled by a bus 400.

Here, the CPU 401 governs overall control of the chemical calculating device 201. The memory 402 includes, for example, a ROM, a RAM, and a flash ROM. For example, the flash ROM and the ROM store various programs, and the RAM is used as a work area for the CPU 401. The programs stored in the memory 402 are loaded onto the CPU 401, whereby the CPU 401 executes encoded processes.

The network I/F 403 is coupled to the network 210 through a communications line and is coupled to other computers via the network 210. The network I/F 403 administers an internal interface with the network 210 and controls the input and output of data from other computers. The network I/F 403 is, for example, a modem or a LAN adapter.

The recording medium I/F 404 controls the reading and writing of data with respect to the recording medium 405 under the control of the CPU 401. The recording medium I/F 404 is, for example, a disk drive, an SSD, a USB port, etc. The recording medium 405 is a nonvolatile memory that stores therein data written thereto under the control of the recording medium I/F 404. The recording medium 405 is, for example, a disk, a semiconductor memory, a USB memory, etc. The recording medium 405 may be removable from the chemical calculating device 201.

The housing I/F 406 controls access to the housing 407 under the control of the CPU 401. The housing I/F 406 converts signals output from the CPU 401 into input signals for the housing 407 using a microwave pulse generator and transmits the converted signals to the housing 407. The housing I/F 406 converts the signals output from the housing 407 into input signals for the CPU 401 using a microwave pulse demodulator and transmits the converted signals to the CPU 401. The housing 407 is a computing device equipped with one or more qubit chips cooled to an extremely low temperature of 10 mK. Each qubit chip represents, for example, a logical qubit. The housing 407 performs a predetermined computation according to an input signal using one or more qubit chips, and outputs an output signal corresponding to the result of performing the predetermined computation.

In addition to the components above, the chemical calculating device 201 may have, for example, a keyboard, a mouse, a display, a printer, a scanner, a microphone, a speaker, etc. The chemical calculating device 201 may also have the recording medium I/F 404 and recording medium 405 in plural. Further, in the chemical calculating device 201, the recording medium I/F 404 and the recording medium 405 may be omitted. Further, the qubit chip in the housing 407 may be controlled by a method other than microwaves. The qubit chip in the housing 407 may implement, for example, optical qubits.

An example of a hardware configuration example of the client device 202 is, for example, similar to the example of the hardware configuration of the information processing device 100 depicted in FIG. 3 and thus, description thereof is omitted.

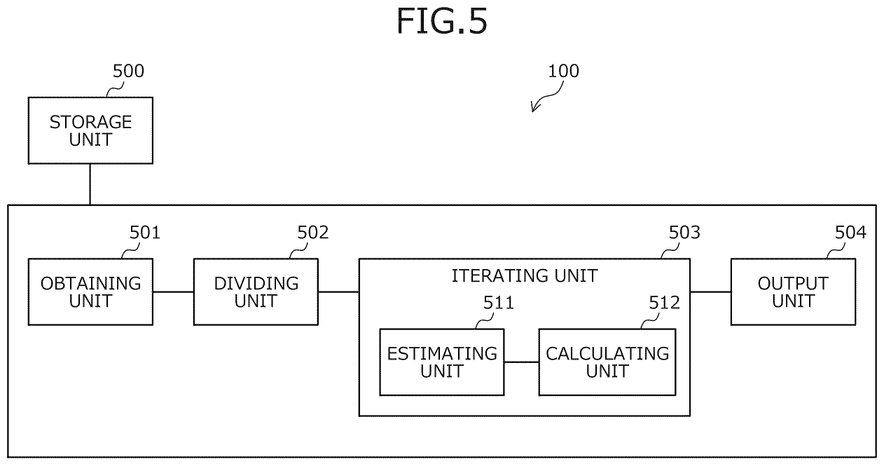

Next, an example of a functional configuration of the information processing device 100 will be described with reference to FIG. 5.

FIG. 5 is a block diagram depicting an example of the functional configuration of the information processing device 100. The information processing device 100 includes a storage unit 500, an obtaining unit 501, a dividing unit 502, an iterating unit 503, and an output unit 504. The iterating unit 503 includes an estimating unit 511 and a calculating unit 512.

The storage unit 500 is implemented by, for example, a storage area such as the memory 302 or the recording medium 305 depicted in FIG. 3. Hereinafter, while a case where the storage unit 500 is included in the information processing device 100 will be described, the present disclosure is not limited hereto. For example, the storage unit 500 may be included in a device different from the information processing device 100, and the storage content of the storage unit 500 may be referable from the information processing device 100.

The obtaining unit 501 to the output unit 504 function as an example of a controller. Specifically, the functions of the obtaining unit 501 to the output unit 504 are realized, for example, by causing the CPU 301 to execute a program stored in a storage area such as the memory 302 or the recording medium 305 depicted in FIG. 3 or by the network I/F 303. The processing result of each functional unit is stored to, for example, a storage area such as the memory 302 or the recording medium 305 depicted in FIG. 3.

The storage unit 500 stores various types of information referred to or updated in the processes of the functional units. The storage unit 500 stores, for example, structural information indicating the structure of a molecule of interest. The structural information includes, for example, coordinates of each atom of multiple atoms forming the molecule of interest. The structural information includes, for example, the type of each of the multiple atoms forming the molecule of interest. The structural information includes, for example, an atomic index of each of the multiple atoms forming the molecule of interest. The structure information is obtained by, for example, the obtaining unit 501. The structure information may be set in advance by the user, for example. The structure information is referred to by, for example, the iterating unit 503.

The storage unit 500 stores, for example, a basis set. The basis set is a set of functions representing molecular orbitals. The basis set is, for example, cc-pV5Z, cc-pVQZ, cc-pVTZ, cc-pVDZ, or STO-3G. The basis set is obtained by, for example, the obtaining unit 501. The basis set may be set in advance by a user, for example. The basis set is referred to by, for example, the iterating unit 503.

The storage unit 500 stores, for example, the number of divisions. The number of divisions indicates, for example, how many fragments the structure of the molecule of interest is divided into. The number of divisions is, for example, the number of fragments. The division number is obtained by the obtaining unit 501, for example. The number of divisions may be set in advance by the user, for example. The division number is referred to by the dividing unit 502, for example.

The storage unit 500 stores, for example, fragment information indicating each of the multiple fragments obtained by dividing the structure of the molecule of interest. The fragment information includes, for example, an index of each atom of one or more atoms belonging to the fragment among multiple atoms forming the molecule of interest. The fragment information is generated by, for example, the dividing unit 502. The fragment information may be obtained by the obtaining unit 501, for example. The fragment information may be set in advance by the user, for example. The fragment information is referred to by, for example, the iterating unit 503.

The obtaining unit 501 obtains various types of information used for the processes of the functional units. The obtaining unit 501 stores the obtained various types of information to the storage unit 500 or outputs the obtained various types of information to the functional units. The obtaining unit 501 may output various types of information stored in the storage unit 500 to the functional units. The obtaining unit 501 obtains various types of information based on, for example, an operation input of a user. For example, the obtaining unit 501 may receive various types of information from a device different from the information processing device 100.

The obtaining unit 501 obtains, for example, a processing request requesting execution of quantum chemical calculation for a molecule of interest. The processing request may include, for example, structure information. The processing request may include, for example, a basis set. The processing request may include, for example, the number of divisions. The processing request may include, for example, fragment information. Specifically, the obtaining unit 501 obtains the processing request by receiving an input of the processing request based on an operation input of the user. Specifically, the obtaining unit 501 may obtain the processing request by receiving the processing request from another computer. The other computer is, for example, one of the client devices 202.

The obtaining unit 501 obtains, for example, structure information. Specifically, the obtaining unit 501 obtains the structure information by extracting the structure information from the processing request. Specifically, the obtaining unit 501 may obtain the structure information by receiving an input of the structure information based on an operation input of the user. Specifically, the obtaining unit 501 may obtain the structure information by receiving the structure information from another computer. The other computer is, for example, one of the client devices 202.

The obtaining unit 501 obtains, for example, a basis set. Specifically, the obtaining unit 501 obtains the basis set by extracting the basis set from the processing request. Specifically, the obtaining unit 501 may obtain the basis set by receiving an input of the basis set based on an operation input of the user. Specifically, the obtaining unit 501 may obtain the basis set by receiving the basis set from another computer. The other computer is, for example, one of the client devices 202.

The obtaining unit 501 obtains, for example, the number of divisions. Specifically, the obtaining unit 501 obtains the division number by extracting the division number from the processing request. Specifically, the obtaining unit 501 may obtain the division number by receiving an input of the division number based on an operation input of the user. Specifically, the obtaining unit 501 may obtain the division number by receiving the division number from another computer. The other computer is, for example, one of the client devices 202.

The obtaining unit 501 obtains, for example, fragment information. Specifically, the obtaining unit 501 obtains the fragment information by extracting the fragment information from the processing request. Specifically, the obtaining unit 501 may obtain the fragment information by receiving an input of the fragment information based on an operation input of the user. Specifically, the obtaining unit 501 may obtain the fragment information by receiving the fragment information from another computer. The other computer is, for example, one of the client devices 202.

The obtaining unit 501 may receive a start trigger for starting the process of any functional unit. The start trigger is, for example, a predetermined operation input by the user. The start trigger may be, for example, reception of predetermined information from another computer. The start trigger may be, for example, output of predetermined information by any functional unit. For example, the obtaining unit 501 regards obtaining the processing request as a start trigger for starting the processes of the dividing unit 502 and the iterating unit 503.

The dividing unit 502 divides the structure of the molecule of interest into multiple fragments corresponding to the number of divisions obtained by the obtaining unit 501, based on the structure information obtained by the obtaining unit 501 and thereby generates fragment information indicating each fragment. For example, the dividing unit 502 divides the structure of the molecule of interest into multiple fragments so that each fragment includes an atom other than hydrogen and a hydrogen atom directly connected to the atom other than hydrogen. Thus, the dividing unit 502 may reduce the workload on the user when generating fragment information.

The iterating unit 503 calculates the energy of the molecule of interest based on the energy of each of the multiple fragments obtained by dividing the structure of the molecule of interest by the molecule dividing method. Examples of the molecular division method include BE and DMET. The iterating unit 503 sets a Hamiltonian of each of the multiple fragments based on, for example, the structure information, the basis set, and the fragment information.

For example, the iterating unit 503 iteratively performs a series of processes by the estimating unit 511 and the calculating unit 512 until a predetermined exit condition is satisfied. The predetermined exit condition is set in advance by the user, for example. The predetermined exit condition is, for example, that the sum of the number of atoms of each fragment matches the number of atoms of the molecule. Thus, the iterating unit 503 may perform quantum chemical calculation for calculating the energy of the molecule of interest.

For each fragment, the estimating unit 511 estimates, for each parameter of multiple parameters included in a first variational quantum circuit representing a Hamiltonian of the fragment, a noise-removed candidate value constituting a solution of the parameter.

For example, the estimating unit 511 obtains, for each fragment, multiple candidate values that are calculated by the VQE and may be solutions of the parameters included in the first variational quantum circuit. Specifically, the estimating unit 511 sets the first variational quantum circuit for each fragment. Specifically, the estimating unit 511 sets, for each fragment, one or more second variational quantum circuits that are logically equivalent to the first variational quantum circuit, have multiple parameters common to the first variational quantum circuit, and have a larger scale than the first variational quantum circuit.

The second variational quantum circuit is formed, for example, by coupling one or more pairs of the first variational quantum circuit and a third variational quantum circuit obtained by inverting the front and back of the first variational quantum circuit, and then coupling the first variational quantum circuit. Therefore, the second variational quantum circuit has, for example, multiple parameters in common with the first variational quantum circuit. The second variational quantum circuit is considered to be affected by, for example, a multiple of reference noise that may occur when the first variational quantum circuit is executed.

Specifically, the estimating unit 511 executes the set first variational quantum circuit for each fragment to calculate a first candidate value that may be a solution of each parameter included in the first variational quantum circuit, by the VQE. The first candidate value is treated as a candidate value affected by one time the reference noise. The estimating unit 511 may execute the first variational quantum circuit by the information processing device 100 or the chemical calculating device 201.

Specifically, the estimating unit 511 executes each of the set second variational quantum circuits with respect to each of the fragments to calculate a second candidate value that may be a solution of each of the parameters included in the first variational quantum circuit, by the VQE. The second candidate value is treated as a candidate value affected by a multiple of the reference noise. The estimating unit 511 may execute each second variational quantum circuit by the information processing device 100 or the chemical calculating device 201.

Accordingly, the estimating unit 511 may obtain multiple candidate values having different degrees of influence of noise, and may estimate a candidate value that is not influenced by noise. Specifically, the estimating unit 511 treats the noise as being affected by 0 times the reference noise, and may estimate a candidate value assumed not to be affected by the reference noise.

For example, for each fragment, the estimating unit 511 estimates, for each parameter of the first variational quantum circuit, a candidate value from which noise has been removed, which is a solution of the parameter, based on the obtained multiple candidate values. The multiple candidate values include, for example, the calculated first candidate value and the calculated second candidate value. Specifically, the estimating unit 511 estimates, for each fragment, a candidate value assumed not to be affected by reference noise, based on the multiple obtained candidate values by linear approximation for each parameter of the first variational quantum circuit. Thus, the estimating unit 511 may accurately calculate the solution of each parameter of the first variational quantum circuit, for each fragment.

The calculating unit 512 calculates the energy of each fragment based on the noise-removed candidate value estimated by the estimating unit 511, for each parameter. For example, the calculating unit 512 calculates the RDM for each fragment based on the noise-removed candidate value estimated by the estimating unit 511, for each parameter. For example, the calculating unit 512 calculates the energy of each fragment based on the calculated RDM. Accordingly, the calculating unit 512 may accurately calculate the energy of each fragment from which the influence of noise caused by the actual quantum computer is removed.

The iterating unit 503 calculates the energy of the molecule of interest based on the energy of each fragment calculated in a series of processes by the estimating unit 511 and the calculating unit 512. For example, the iterating unit 503 calculates the sum of the calculated energies of the fragments as the energy of the molecule of interest. Accordingly, the iterating unit 503 may appropriately calculate the energy of the molecule of interest.

The iterating unit 503 determines whether the exit condition is satisfied when the energy of each fragment is calculated in a series of processes by the estimating unit 511 and the calculating unit 512. The exit condition is, for example, that the sum of the number of atoms corresponding to each fragment matches the number of atoms corresponding to the molecule of interest. Accordingly, the iterating unit 503 may determine whether the energy of each fragment has been appropriately calculated.

The exit condition may be, for example, that a statistical value of a change amount between the energy of each fragment calculated this time and the energy of each fragment calculated last time is not more than a threshold value. The threshold is set in advance by the user, for example. The statistical value is, for example, a maximum value, a minimum value, an average value, a mode value, or a median value.

When the exit condition is not satisfied, the iterating unit 503 updates the Hamiltonian of each fragment. Accordingly, the iterating unit 503 may optimize the Hamiltonian of each fragment. The iterating unit 503 may allow the energy of each fragment to be recalculated.

The iterating unit 503 re-executes the series of processes by the estimating unit 511 and the calculating unit 512 in response to updating the Hamiltonian of each fragment. Accordingly, the iterating unit 503 may iteratively perform the series of processes by the estimating unit 511 and the calculating unit 512 until the predetermined exit condition is satisfied. The iterating unit 503 may optimize the energy of each fragment.

The output unit 504 outputs a processing result of at least one of the functional units. The output format is, for example, display on a display, print output to a printer, transmission to an external device by the network I/F 303, or storage in a storage area such as the memory 302 or the recording medium 305. Accordingly, the output unit 504 may notify the user of the processing result of at least one of the functional units, and the convenience of the information processing device 100 may be improved.

The output unit 504 outputs, for example, the energy corresponding to the molecule of interest calculated by the iterating unit 503. Specifically, the output unit 504 outputs the energy corresponding to the molecule of interest so that the user may refer to the energy. Specifically, the output unit 504 may transmit the energy corresponding to the molecule of interest to another computer. The other computer is, for example, one of the client devices 202. Thus, the output unit 504 may enable external reference of the energy corresponding to the molecule of interest.

For example, the output unit 504 may output the energy corresponding to each fragment calculated by the iterating unit 503. Specifically, the output unit 504 outputs the energy corresponding to each fragment so that the user may refer to the energy. Specifically, the output unit 504 may transmit the energy corresponding to each fragment to another computer. The other computer is, for example, one of the client devices 202. Accordingly, the output unit 504 may externally refer to the energy corresponding to each fragment.

Here, while a case in which the information processing device 100 includes the obtaining unit 501, the dividing unit 502, the iterating unit 503, and the output unit 504 has been described, the present disclosure is not limited hereto. For example, the information processing device 100 may omit any of the functional units. Specifically, the information processing device 100 may omit the dividing unit 502. In this case, specifically, the information processing device 100 may cooperate with another computer operating as the dividing unit 502. The other computer is, for example, the chemical calculating device 201.

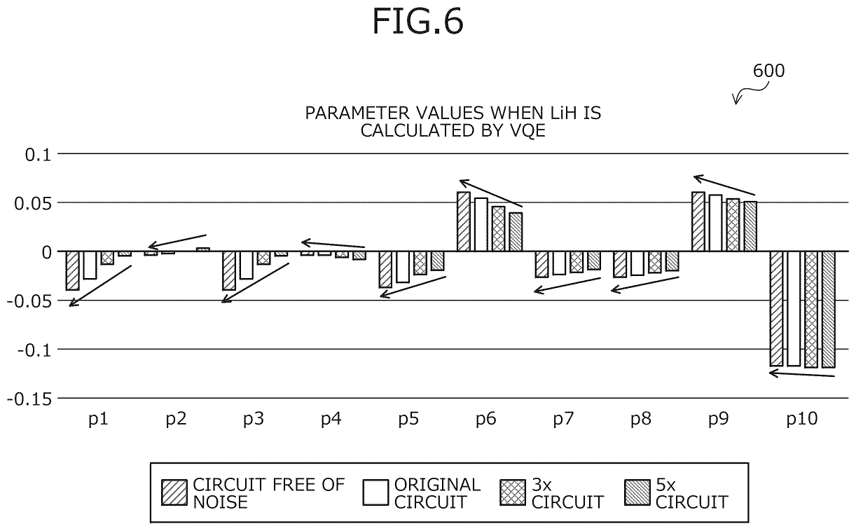

Next, an operation example of the information processing device 100 will be described with reference to FIGS. 6 to 9. First, a policy of the operation of the information processing device 100 will be described with reference to FIG. 6.

FIG. 6 is an explanatory diagram depicting an operation policy. In FIG. 6, it is assumed that values of parameters p1 to p10 of a variational quantum circuit are calculated by VQE by executing variational quantum circuits having different degrees of influence of noise for a molecule LiH via a quantum simulator having noise.

Specifically, it is assumed that a variational quantum circuit in which the influence of noise does not occur is executed via the quantum simulator having noise. Specifically, it is assumed that a variational quantum circuit in which the influence of the reference noise occurs, a variational quantum circuit in which the influence of three times the reference noise occurs, and a variational quantum circuit in which the influence of five times the reference noise occurs are executed via the quantum simulator having noise.

A graph 600 depicted in FIG. 6 depicts values of parameters p1 to p10 of the variational quantum circuit calculated by the VQE by executing the variational quantum circuits having different degrees of influence of noise. Here, the values of the parameters p1 to p10 of the variational quantum circuit calculated by the VQE by executing the variational quantum circuit in which the influence of noise does not occur are denoted by an identifier of “noiseless circuit”.

In addition, the values of the parameters p1 to p10 of the variational quantum circuit calculated by the VQE by executing the variational quantum circuit in which the influence of noise as a reference occurs are indicated by attaching an identifier “original circuit”. In addition, the values of the parameters p1 to p10 of the variational quantum circuit calculated by the VQE by executing the variational quantum circuit in which the influence corresponding to three times of the reference noise occurs are denoted by an identifier “3× circuit”. In addition, the values of the parameters p1 to p10 of the variational quantum circuit calculated by the VQE by executing the variational quantum circuit in which the influence corresponding to five times of the reference noise is generated are denoted by an identifier of “5× circuit”.

As depicted in the graph 600, the values of the parameters p1 to p10 of the variational quantum circuit have a property of monotonically changing according to a change in the degree of influence of noise. Therefore, when multiple values affected by noise are found for the parameters p1 to p10 of the variational quantum circuit, it is considered that a value not affected by noise may be estimated.

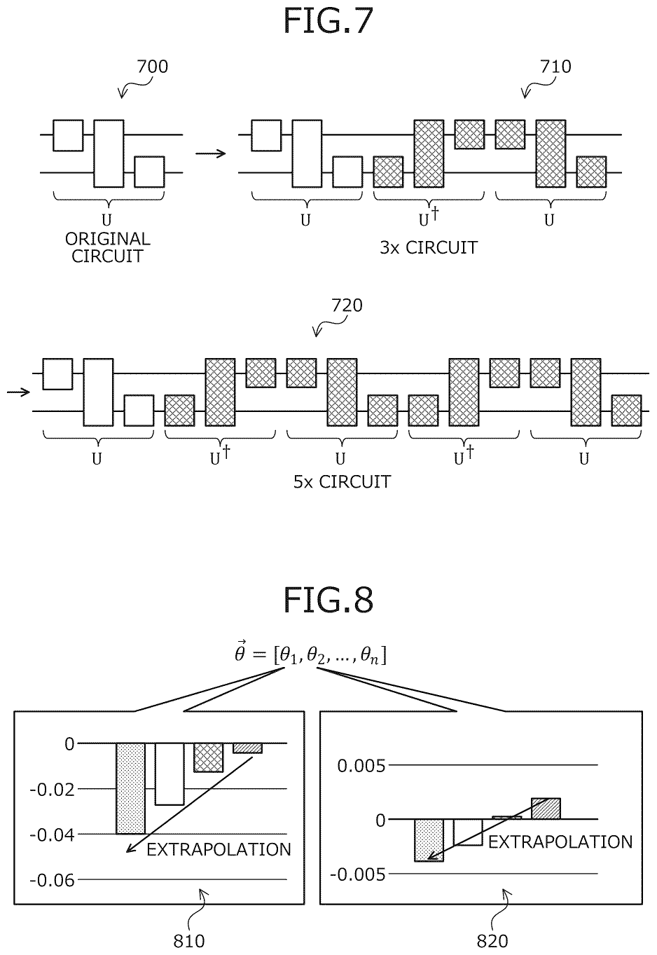

Therefore, it is assumed that the information processing device 100 operates in a policy of improving the accuracy of the calculation of the energy of the molecule by estimating a value that is not affected by noise with respect to the parameter of the variational quantum circuit in the process of performing the molecule dividing method to which the VQE is applied. Next, an operation example of the information processing device 100 will be described with reference to FIGS. 7 and 8.

FIGS. 7 and 8 are explanatory diagrams depicting an operation example of the information processing device 100. In FIG. 7, the information processing device 100 divides the structure of a molecule of interest into multiple fragments. The information processing device 100 sets a Hamiltonian of each fragment. The information processing device 100 iteratively performs a series of processes of calculating the energy of each fragment until an exit condition is satisfied.

The exit condition is that the sum of the number of atoms of each fragment matches the number of atoms of the molecule. When the exit condition is not satisfied, the information processing device 100 updates the Hamiltonian of each fragment. Here, how the information processing device 100 performs a series of processes of calculating the energy of each fragment will be described.

(7-1) For example, the information processing device 100 sets, for each fragment, a variational quantum circuit 700 expressing the Hamiltonian of the fragment. The variational quantum circuit 700 is treated as being affected by one time the reference noise. The noise is due to components of the variational quantum circuit 700. The component corresponds to a quantum gate or the like. The variational quantum circuit 700 has a parameter θ_{→}. θ_{→} indicates that _{→} is attached above θ. θ_{→}=[θ₁, θ₂, . . . , θₙ]. n is the number of parameters.

(7-2) For example, the information processing device 100 sets a variational quantum circuit 710 that handles each fragment as being affected by three times the noise. Specifically, assuming that the variational quantum circuit 700 is U, the information processing device 100 sets a variational quantum circuit 710 in which U, U†, and U are sequentially connected. Since the variational quantum circuit 710 includes the same components as those of the variational quantum circuit 700 by three times as much as those of the variational quantum circuit 700, the variational quantum circuit 710 is treated as being affected by three times the reference noise. Since the variational quantum circuit 710 is a combination of U and U†, it has a parameter θ_{→} in common with the variational quantum circuit 700.

(7-3) The information processing device 100 sets, for example, a variational quantum circuit 720 that handles each fragment as being affected by five times the noise. Specifically, assuming that the variational quantum circuit 700 is U, the information processing device 100 sets a variational quantum circuit 720 in which U, U†, U, U†, and U are sequentially connected. Since the variational quantum circuit 720 includes the same components as those of the variational quantum circuit 700 by five times the number of the variational quantum circuit 700, the variational quantum circuit 720 is treated as being affected by five times the reference noise. Since the variational quantum circuit 720 is a combination of U and U†, it has a parameter θ_{→} in common with the variational quantum circuit 700. Next, FIG. 8 will be described.

In FIG. 8, (8-1) the information processing device 100 uses the chemical calculating device 201 to execute the variational quantum circuit 700 for each fragment, thereby calculating the value of the parameter θ_{→} affected by one time the reference noise by the VQE. Specifically, the information processing device 100 calculates values θ₁⁽¹⁾, θ₂⁽¹⁾, . . . , and θₙ⁽¹⁾ of the parameter θ_{→}.

(8-2) The information processing device 100 uses the chemical calculating device 201 to execute the variational quantum circuit 710 for each fragment, thereby calculating the value of the parameter θ_{→} affected by three times the reference noise by the VQE. Specifically, the information processing device 100 calculates the values θ₁⁽³⁾, θ₂⁽³⁾, . . . , and θₙ⁽³⁾ of the parameter θ_{→}.

(8-3) The information processing device 100 executes the variational quantum circuit 720 for each fragment using the chemical calculating device 201 to calculate the value of the parameter θ_{→} affected by five times the reference noise by the VQE. Specifically, the information processing device 100 calculates values θ₁⁽⁵⁾, θ₂⁽⁵⁾, . . . , and θₙ⁽⁵⁾ of the parameter θ_{→}.

(8-4) The information processing device 100 calculates, for each fragment, a value of the parameter θ_{→} treated as not being affected by the reference noise based on the calculated value of the parameter θ_{→}. Specifically, the information processing device 100 calculates values θ₁⁽⁰⁾, θ₂ ⁽⁰⁾, . . . , and θₙ(0) of the parameter θ_{→}.

In the example depicted in FIG. 8, specifically, as depicted in a graph 810, the information processing device 100 calculates a value θ₁(0) treated as not being affected by noise by linear approximation based on a value θ₁⁽¹⁾, a value θ₁⁽³⁾, and a value θ₁(5) for the parameter θ₁. Similarly, specifically, as depicted in a graph 820, the information processing device 100 calculates a value θ₂⁽⁰⁾ treated as not being affected by noise by linear approximation based on the value θ₂⁽¹⁾, the value θ₂⁽³⁾, and the value θ₂(5) for the parameter θ₂. Similarly, specifically, the information processing device 100 calculates values θ₃⁽⁰⁾ and . . . θₙ⁽⁰⁾ treated as not being affected by noise for the parameters θ₃ and . . . θₙ.

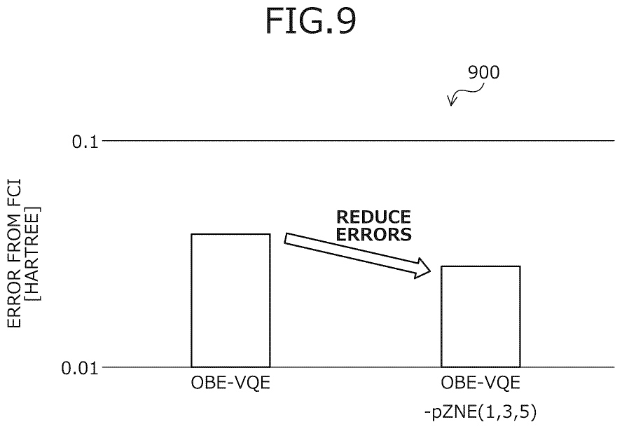

(8-5) The information processing device 100 calculates 1,2-RDM for each fragment based on the calculated values θ₁⁽⁰⁾, θ₂⁽⁰⁾, . . . , and θₙ⁽⁰⁾ of the parameter θ_{→}. The information processing device 100 calculates the energy and the number of atoms of each fragment based on the calculated 1,2-RDM. Accordingly, the information processing device 100 may suppress the influence of noise in the actual quantum computer and accurately calculate the energy and the number of atoms of the fragment. Next, an example of an effect of the information processing device 100 will be described with reference to FIG. 9.

FIG. 9 is an explanatory diagram depicting an example of an effect. In FIG. 9, the conventional method and the proposed method executed by the information processing device 100 are compared. In the conventional method, the energy of a molecule is calculated by BE to which VQE is applied. As described above, in the proposed method, in the process of calculating the energy of the molecule by BE to which VQE is applied, the value of the parameter treated as not being affected by noise is calculated. In the example depicted in FIG. 9, it is assumed that the molecule is C3H8.

A graph 900 represents an error of the molecular energy calculated by the conventional method and the proposed method in a case where the molecular energy calculated by the FCI is a correct answer. As depicted in the graph 900, the proposed method may reduce the error of the molecular energy as compared with the conventional method.

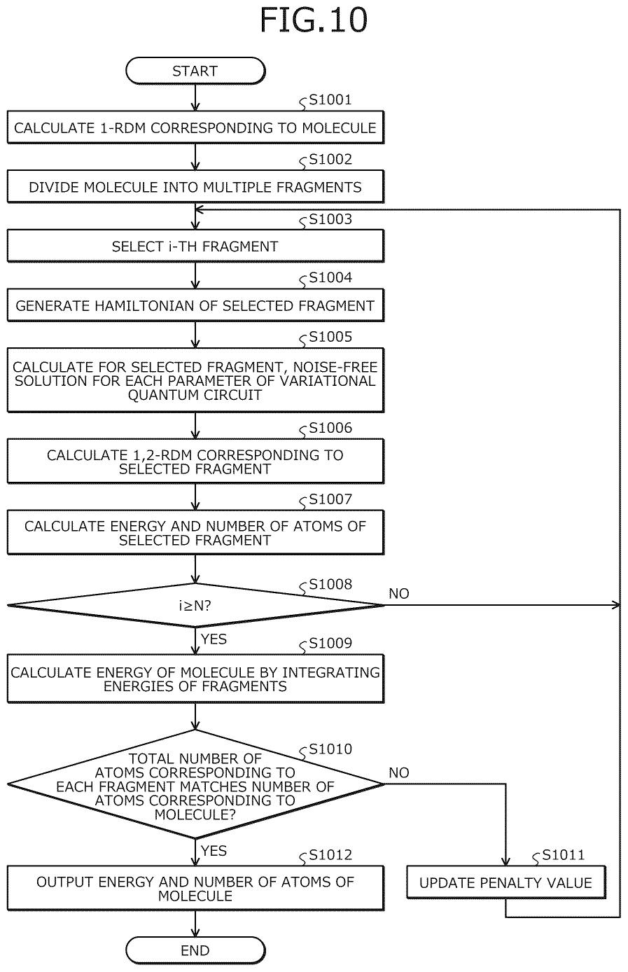

Next, an example of a procedure of an overall process executed by the information processing device 100 will be described with reference to FIG. 10. The overall process is implemented by, for example, the CPU 301, storage areas such as the memory 302 and the recording medium 305, and the network I/F 303 depicted in FIG. 3.

FIG. 10 is a flowchart depicting an example of the procedure of the overall process. In FIG. 10, the information processing device 100 calculates 1-RDM corresponding to the molecule (step S1001). Then, the information processing device 100 divides the molecule into multiple fragments (step S1002).

Next, the information processing device 100 selects the i-th fragment (step S1003). Then, the information processing device 100 generates a Hamiltonian of the selected fragment based on a penalty value (step S1004).

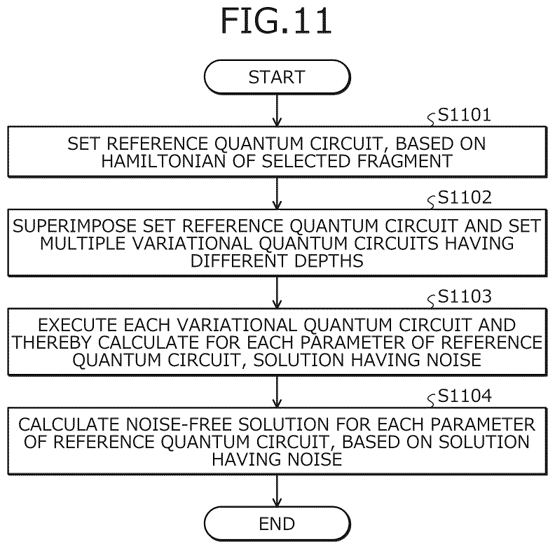

Next, the information processing device 100 calculates for the selected fragment, a noise-free solution for each parameter of the variational quantum circuit by executing a calculation process described later with reference to FIG. 11 (step S1005). Then, the information processing device 100 calculates 1,2-RDM corresponding to the selected fragment (step S1006).

Next, the information processing device 100 calculates the energy and the number of atoms of the selected fragment (step S1007). Then, the information processing device 100 determines whether i≥N is satisfied (step S1008). N is the total number of fragments.

Here, when i<N is true (step S1008: NO), the information processing device 100 increments i and returns to the process at step S1003. On the other hand, when i≥N is true (step S1008: YES), the information processing device 100 proceeds to the process at step S1009.

At step S1009, the information processing device 100 calculates the energy of the molecule by integrating the energies of the fragments (step S1009). Next, the information processing device 100 determines whether the total number of atoms corresponding to each fragment matches the number of atoms corresponding to the molecule (step S1010).

When the numbers do not match (step S1010: NO), the information processing device 100 proceeds to the process at step S1011. On the other hand, when the numbers match (step S1010: YES), the information processing device 100 proceeds to the process at step S1012.

At step S1011, the information processing device 100 updates the penalty value (step S1011), sets i to 0, and returns to the process at step S1003. At step S1012, the information processing device 100 outputs the energy and the number of atoms of the molecule (step S1012), and ends the entire process.

Next, an example of a procedure of the calculation process executed by the information processing device 100 will be described with reference to FIG. 11. The calculation process is implemented by, for example, the CPU 301, the storage area such as the memory 302 or the recording medium 305, and the network I/F 303 depicted in FIG. 3.

FIG. 11 is a flowchart depicting an example of the procedure of the calculation process. In FIG. 11, the information processing device 100 sets a reference quantum circuit, based on the Hamiltonian of the selected fragment (step S1101).

Next, the information processing device 100 superimposes the set reference quantum circuit and sets multiple variational quantum circuits having different depths (step S1102). Then, the information processing device 100 executes each variational quantum circuit and thereby calculates for each parameter of the reference quantum circuit, a solution having noise (step S1103).

Next, the information processing device 100 calculates a noise-free solution for each parameter of the reference quantum circuit, based on the solution having noise (step S1104). Then, the information processing device 100 ends the calculation process.

Here, the information processing device 100 may change the order of the processes of some steps of the flowcharts in FIGS. 10 and 11. In addition, the information processing device 100 may omit processes of some steps of the flowcharts in FIGS. 10 and 11.

The information processing device 100 may be applied to fields such as drug discovery and material development. Specifically, in the field of drug discovery, material development, or the like. The information processing device 100 may be applied to a case where it is desired to perform quantum chemical calculation for calculating the basis energy of a molecule in order to analyze the structure or properties of the molecule, which is a candidate for a drug or a material. As a result, the information processing device 100 may reduce the processing time necessary to perform the quantum chemical calculation while maintaining the accuracy of the quantum chemical calculation, facilitating the calculation of the basis energy of the molecule, and contributing to the fields of drug discovery, material development, and the like.

As described above, according to the information processing device 100, it is possible to calculate the energy of the molecule based on the energy of each fragment of the multiple fragments obtained by dividing the structure of the molecule by the molecule dividing method. According to the information processing device 100, for each fragment, multiple parameters included in the first variational quantum circuit expressing the Hamiltonian of the fragment may be specified. According to the information processing device 100, it is possible to obtain multiple candidate values which are calculated by the VQE, for each parameter and may be solutions of the parameter, for each fragment. According to the information processing device 100, for each fragment, it is possible to estimate a candidate value from which noise has been removed based on multiple obtained candidate values for each parameter. According to the information processing device 100, for each fragment, the energy of the fragment may be calculated based on the noise-removed candidate values estimated for each parameter. Thus, the information processing device 100 may improve the accuracy of the calculation of the energy of the molecule.

According to the information processing device 100, it is possible to set one or more second variational quantum circuits that are logically equivalent to the first variational quantum circuit, have multiple parameters in common with the first variational quantum circuit, and have a larger scale than the first variational quantum circuit. According to the information processing device 100, it is possible to calculate multiple candidate values that may be solutions of the respective parameters by the VQE, using the respective second variational quantum circuits and the first variational quantum circuits for the respective fragments via the actual machine of the quantum computer. Thus, the information processing device 100 may calculate multiple candidate values useful for estimating a candidate value from which noise has been removed.

According to the information processing device 100, it is possible to set the second variational quantum circuit formed by coupling one or more pairs of the first variational quantum circuit and the third variational quantum circuit obtained by inverting the front and back of the first variational quantum circuit, and then coupling thereto the first variational quantum circuit. As a result, the information processing device 100 may set the second variational quantum circuit having a different degree of influence of noise from the first variational quantum circuit and calculate a candidate value useful for estimating a candidate value from which noise has been removed.

According to the information processing device 100, the energy of the molecule may be calculated based on the calculated energy of each fragment. Thus, the information processing device 100 may complete the quantum chemical calculation for calculating the energy of the molecule.

According to the information processing device 100, in a case where the exit condition is not satisfied when the energy of each fragment is calculated, the Hamiltonian of each fragment may be updated. According to the information processing device 100, the estimation process and the calculation process may be re-executed in response to the update of the Hamiltonian of each fragment. Thus, the information processing device 100 may optimize the Hamiltonian and accurately calculate the energy of the molecule.

According to the information processing device 100, the structure of a molecule may be divided into multiple fragments. Thus, the information processing device 100 may identify multiple fragments by itself. The information processing device 100 may reduce the workload on the user when dividing the molecular structure into multiple fragments.

According to the information processing device 100, DMET may be employed as the molecular division method. Thus, the information processing device 100 may improve the accuracy of the calculation of the energy of the molecule by DMET.

The information processing method described in the present embodiment may be implemented by executing a prepared program on a computer such as a personal computer and a workstation. The program is stored on a non-transitory, computer-readable recording medium such as a hard disk, a flexible disk, a compact disc read-only memory (CD-ROM), a magneto-optical (MO) disc, and a digital versatile disc (DVD), read out from the computer-readable medium, and executed by the computer. The program may be distributed through a network such as the Internet.

According to one aspect of the present disclosure, it become possible to improve the accuracy of the calculation of molecular energy by a molecule dividing method.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-readable recording medium storing therein a program for causing a computer to execute a process, the process comprising:
calculating energy of a molecule based on energy of each of a plurality of fragments obtained by dividing a structure of the molecule by a molecule dividing method, the calculating including:
estimating, for each of the plurality of fragments, a candidate value from which noise has been removed, based on a plurality of candidate values that are calculated by a variational quantum eigenvalue solver, each of the plurality of candidate values being calculated for each of a plurality of parameters of a first variational quantum circuit representing a Hamiltonian of the each of the plurality of fragments, the each of the plurality of candidate values being a potential solution of the parameter; and
calculating, for each of the plurality of fragments, an energy thereof based on the candidate value from which noise has been removed and estimated for each of the plurality of parameters.

2. The computer-readable recording medium according to claim 1, the process further comprising calculating, for the each of the plurality of fragments, via an actual machine of a quantum computer, the plurality of candidate values by the variational quantum eigenvalue solver using the first variational quantum circuit and each of one or more second variational quantum circuits that are logically equivalent to the first variational quantum circuit, have the plurality of parameters in common with the first variational quantum circuit, and have a larger scale than the first variational quantum circuit.

3. The computer-readable recording medium according to claim 2, wherein the second variational quantum circuit is formed by coupling one or more pairs of the first variational quantum circuit and a third variational quantum circuit obtained by inverting the first variational quantum circuit, and then coupling thereto the first variational quantum circuit.

4. The computer-readable recording medium according to claim 1, wherein the calculating the energy includes calculating the energy based on the energy calculated for the each of the plurality of fragments.

5. The computer-readable recording medium according to claim 4, the process further comprising updating the Hamiltonian of the each of the plurality of fragments when an exit condition is not satisfied when the energy of the each of the plurality of fragments is calculated, wherein
the estimating and the calculating the energy for the each of the plurality of fragments are re-executed in response to updating the Hamiltonian of the each of the plurality of fragments.

6. The computer-readable recording medium according to claim 1, further comprising dividing the structure of the molecule into the plurality of fragments.

7. The computer-readable recording medium according to claim 1, wherein the molecule dividing method is Density Matrix Embedding Theory or Bootstrap Embedding.

8. An information processing method executed by a computer, the method comprising:
calculating energy of a molecule based on energy of each of a plurality of fragments obtained by dividing a structure of the molecule by a molecule dividing method, the calculating including:
estimating, for each of the plurality of fragments, a candidate value from which noise has been removed, based on a plurality of candidate values that are calculated by a variational quantum eigenvalue solver, each of the plurality of candidate values being calculated for each of a plurality of parameters of a first variational quantum circuit representing a Hamiltonian of the each of the plurality of fragments, the each of the plurality of candidate values being a potential solution of the parameter; and
calculating, for each of the plurality of fragments, an energy thereof based on the candidate value from which noise has been removed and estimated for each of the plurality of parameters.

9. An information processing device comprising:
a memory; and
a processor coupled to the memory, the processor configured to:
calculate energy of a molecule based on energy of each of a plurality of fragments obtained by dividing a structure of the molecule by a molecule dividing method, in calculating the energy, the processor being further configured to:
estimate, for each of the plurality of fragments, a candidate value from which noise has been removed, based on a plurality of candidate values that are calculated by a variational quantum eigenvalue solver, each of the plurality of candidate values being calculated for each of a plurality of parameters of a first variational quantum circuit representing a Hamiltonian of the each of the plurality of fragments, the each of the plurality of candidate values being a potential solution of the parameter; and
calculate, for each of the plurality of fragments, an energy thereof based on the candidate value from which noise has been removed and estimated for each of the plurality of parameters.
